(19) United States
(12) Patent Application Publication
(10) Pub. No.: US 2025/0262928 A1
(43) Pub. Date: Aug. 21, 2025

(54) HYBRID ELECTRIC VEHICLE

(71) Applicant: TOYOTA JIDOSHA KABUSHIKI KAISHA, Toyota-shi (JP)

(72) Inventors: Koshiro KOSAKA, Nagakute-shi (JP); Yasutaka TSUCHIDA, Toyota-shi (JP)

(73) Assignee: TOYOTA JIDOSHA KABUSHIKI KAISHA, Toyota-shi (JP)

(21) Appl. No.: 19/007,933

(22) Filed: Jan. 2, 2025

(30) Foreign Application Priority Data
Feb. 16, 2024 (JP) 2024-022250

(51) Int. Cl. B60K 6/442

(52) U.S. Cl. CPC B60K 6/442

(57) ABSTRACT

A hybrid electric vehicle includes an engine, a first motor, a planetary gear connected to the first motor, the engine, and a drive shaft connected to drive wheels, a second motor connected to the drive shaft, a power storage device connected to the first motor and the second motor via a power line, and a control device that controls the engine, the first motor, and the second motor so as to travel with intermittent operation of the engine. The control device controls the first motor by setting a smaller value as the torque command of the first motor than when the temperature of the first motor is equal to or higher than the predetermined temperature when the starting condition is satisfied and the engine is started with cranking of the engine by the first motor during traveling and the temperature of the first motor is lower than the predetermined temperature.

### CROSS-REFERENCE TO RELATED APPLICATION

This application claims priority to Japanese Patent Application No. 2024-022250 filed on Feb. 16, 2024, incorporated herein by reference in its entirety.

### BACKGROUND

### 1. Technical Field

The present disclosure relates to a hybrid electric vehicle.

### 2. Description of Related Art

A hybrid electric vehicle has been proposed (see, for example, Japanese Unexamined Patent Application Publication No. 2012-106598 (JP 2012-106598 A)). In this hybrid electric vehicle, a first motor, an engine, and a drive shaft are connected to a sun gear of a planetary gear, a carrier, and a ring gear, respectively. The drive shaft is coupled to drive wheels. A second motor is connected to the drive shaft. A power storage device is connected to the first motor and the second motor via a power line. In this hybrid electric vehicle, the engine is started with cranking of the engine achieved by the first motor. At this time, the first motor is controlled such that a relatively large first torque is output from the first motor until the rotation speed of the engine reaches a torque lowering start rotation speed. Once the rotation speed of the engine reaches the torque lowering start rotation speed, the first motor is controlled such that a second torque that is smaller than the first torque is output from the first motor. In this case, the torque lowering start rotation speed is set based on whether or not a crank angle at the time of initiating the starting falls within a predetermined crank angle range. This suppresses vibration at the time of starting the engine.

### SUMMARY

In the hybrid electric vehicle with a hardware configuration as described above, a start condition is met during traveling, and the engine is started with cranking of the engine achieved by the first motor. At this time, the first motor is regeneratively driven at an initial stage of the cranking of the engine, and the first motor is then driven by powering. Based on this, starting the engine while protecting the power storage device is required. In general, it is known in regard to the first motor that a magnet torque is larger and an actual torque is thus larger when the temperature of the first motor is low than when the temperature of the first motor is high, in response to the same torque command. Due to this characteristic, there is a possibility that input power of the power storage device becomes relatively large when the first motor is controlled with the same value set in a torque command of the first motor regardless of the temperature of the first motor. This is because electric power generated through regenerative driving of the first motor at the initial stage of cranking of the engine becomes relatively large when the temperature of the first motor is low.

A main object of the hybrid electric vehicle according to the present disclosure is to suppress a relative increase in input power of a power storage device when an engine is started during traveling.

In order to achieve the above-described main object, the hybrid electric vehicle of the present disclosure adopts the following measures.

The disclosed hybrid electric vehicle includes:
an engine;
a first motor;
a planetary gear that is connected to the first motor, the engine, and a drive shaft connected to drive wheels;
a second motor that is connected to the drive shaft;
a power storage device that is connected to the first motor and the second motor via a power line; and
a control device that controls the engine, the first motor, and the second motor to travel with an intermittent operation of the engine,
and
if a temperature of the first motor is less than a predetermined temperature when a start condition is met during traveling and the engine is started with cranking of the engine achieved by the first motor, the control device sets a smaller value than a value set when the temperature of the first motor is equal to or greater than the predetermined temperature in a torque command of the first motor and controls the first motor,
according to the gist.

In the hybrid electric vehicle of the present disclosure, a start condition may be met during traveling, and the engine may be started with cranking of the engine achieved by the first motor. At this time, when a temperature of the first motor is lower than a predetermined temperature, a smaller value than a value set when the temperature of the first motor is equal to or greater than the predetermined temperature is set in a torque command of the first motor, and the first motor is controlled. It is thus possible to suppress an increase in actual torque of the first motor when the temperature of the first motor is less than the predetermined temperature as compared with the actual torque when the temperature of the first motor is equal to or greater than the predetermined temperature. Therefore, it is possible to suppress a relative increase in power generated through regenerative driving of the first motor at the initial stage of the cranking of the engine and to suppress a relative increase in input power of the power storage device when the temperature of the first motor is less than the predetermined temperature. Here, a temperature of a permanent magnet of the first motor may be used, or a coil temperature of the first motor may be used, or a temperature of a lubricating oil for oil-cooling the first motor may be used, as the temperature of the first motor.

In the hybrid electric vehicle according to the present disclosure, the control device may set a start determination vehicle speed such that input power of the power storage device when the engine is started during traveling falls within a range of allowable input power, and the start condition may include a condition that a vehicle speed is equal to or greater than the start determination vehicle speed. In this case, a relative increase in input power of the power storage device at the initial stage of cranking of the engine when the temperature of the first motor is less than the predetermined temperature is suppressed as described above. It is thus possible to suppress setting of a relatively low start determination vehicle speed and to suppress narrowing of an allowable vehicle speed region of electric traveling accompanying stop of the engine.

In the hybrid electric vehicle according to the present disclosure, if the temperature of the first motor is less than the predetermined temperature when the engine is started during traveling, the control device may set a smaller value in the torque command as the temperature of the first motor is lower.

In the hybrid electric vehicle according to the present disclosure, the control device may set the torque command such that a torque increases up to a first torque, is held, and then decreases once a decreasing start condition is met when the engine is started during traveling, and the decreasing start condition may include a crank angle condition that a crank angle of the engine falls within a predetermined crank angle range when a vehicle speed is less than a predetermined vehicle speed, and the decreasing start condition may not include the crank angle condition when the vehicle speed is equal to or greater than the predetermined vehicle speed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a hybrid electric vehicle 20 according to an embodiment of the present disclosure;

FIG. 2 is an explanatory diagram illustrating an exemplary configuration of a cranking torque Tcr;

FIG. 3 is an explanatory diagram illustrating an example of the relationship between the rotational speeds of the rotating elements of the planetary gear 30 when the engine 22 is started;

FIG. 4 is a flow chart illustrating an exemplary process routine executed by HVECU70; and

FIG. 5 is an explanatory diagram illustrating an example of a low-temperature map.

### DETAILED DESCRIPTION OF EMBODIMENTS

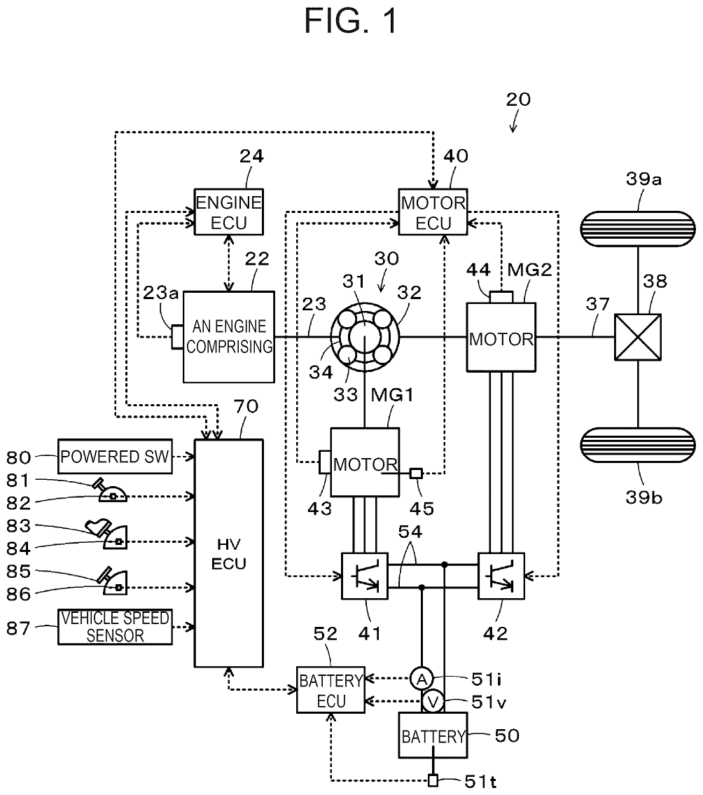

Embodiments for carrying out the present disclosure will be described with reference to the drawings. FIG. 1 is a schematic configuration diagram of a hybrid electric vehicle 20 according to an embodiment of the present disclosure. As illustrated in FIG. 1, hybrid electric vehicle 20 of the embodiment includes an engine 22, a planetary gear 30, motors MG1, MG2, inverters 41 and 42, a battery 50, and a hybrid-use electronic control unit 70. The electronic control unit for hybrids is hereinafter referred to as “HVECU”.

The engine 22 is configured as an internal combustion engine that outputs power using fuel such as gasoline and gas oil. The crankshaft 23 of the engine 22 is connected to the carrier 34 of the planetary gear 30. The operation of the engine 22 is controlled by an electronic control unit for an engine (hereinafter, referred to as an “engine ECU”) 24.

The engine ECU24 includes a microcomputer having a CPU, ROM, RAM, a flash memory, an input/output port, and a communication port. The engine ECU24 receives signals from various sensors via an input port. For example, the engine ECU24 receives the crank angle θcr from the crank position sensor 23a that detects the rotational position of the crankshaft 23. The engine ECU24 outputs various control signals via an output port. For example, the engine ECU24 outputs a control signal to an intake valve, a fuel injection valve, and a spark plug (both not shown). The engine ECU24 calculates the rotational speed Ne of the engine 22 based on the crank angle θcr of the crankshaft 23. The engine ECU24 communicates with HVECU70.

The planetary gear 30 is configured as a single pinion type planetary gear mechanism. The planetary gear 30 includes a sun gear 31 of an external gear, a ring gear 32 of an internal gear, a plurality of pinion gears 33, and a carrier 34. The plurality of pinion gears 33 mesh with the sun gear 31 and the ring gear 32, respectively. The carrier 34 supports the plurality of pinion gears 33 so as to rotate and revolve freely. The sun gear 31 is connected to the rotor of the motor MG1. The ring gear 32 is connected to a drive shaft 37 20 connected to the drive wheels 39a, 39b via a differential gear 38. The carrier 34 is connected to the crankshaft 23 of the engine 22 as described above.

Each of the motors MG1, MG2 is configured as, for example, a synchronous generator motor, and includes a rotor in which permanent magnets are embedded in a rotor core, and a stator in which three-phase coils are wound around the stator core. As described above, the rotor of the motor MG1 is connected to the sun gear 31 of the planetary gear 30. The rotor of the motor MG2 is connected to the drive shaft 37. The inverters 41 and 42 are configured as inverter circuits having a plurality of switching elements. The inverters 41 and 42 are connected to the battery 50 via a power line 54. A smoothing capacitor is attached to the power line 54. The motors MG1, MG2 are rotationally driven by switching control of a plurality of switching elements of the inverters 41 and 42 by a motor electronic control unit (hereinafter referred to as “motor ECU”) 40.

The motor ECU40 comprises a microcomputer as well as an engine ECU24. The motor ECU40 receives signals from various sensors via input ports. For example, the motor ECU40 receives the rotational positions θm1 and θm2 from the rotational position sensors 43 and 44, the phase currents Iu1, Iv1, Iw1, Iu2, Iv2, Iw2 from the current sensor, and the temperature αm1 from the temperature sensor 45. The rotational position sensors 43 and 44 detect the rotational position of the rotor of the motors MG1, MG2. The current sensor detects a phase current of each phase of the motors MG1, MG2. The temperature sensor 45 detects the temperature of the motor MG1. As the temperature sensor 45, for example, a sensor that detects any one of the temperature of the permanent magnets of the motor MG1, the temperature of the coil of the motor MG1, and the temperature of the lubricating oil for oil-cooling the motor MG1 as the temperature αm1 of the motor MG1 is used. The motor ECU40 outputs various control signals via an output port. For example, the motor ECU40 outputs control signals to the inverters 41 and 42. The motor ECU40 calculates the electric angles θe1 and θe2 and the rotational speeds Nm1, Nm2 of the motors MG1, MG2 based on the rotational positions θm1 and θm2 of the rotor of the motors MG1, MG2. The motor ECU40 communicates with HVECU70.

The battery 50 is configured as, for example, a lithium-ion secondary battery or a nickel-hydrogen secondary battery. As described above, the battery 50 is connected to the inverters 41 and 42 via the power line 54. The battery 50 is managed by a battery electronic control unit (hereinafter referred to as “battery ECU”) 52.

The battery ECU52 comprises a microcomputer as well as an engine ECU24. The battery ECU52 receives signals from various sensors via input ports. For example, the battery ECU52 receives a voltage Vb from the voltage sensor 51v, a current Ib from the current sensor 51i, and a temperature Tb from the temperature sensor 51t. The voltage-sensor 51v is mounted between terminals of the battery 50. The current sensor 51i is attached to the output terminal of the battery 50. The temperature sensor 51t is attached to the battery 50. The battery ECU52 calculates the power storage ratio SOC of the battery 50 based on the integrated value of the current Ib of the battery 50. The battery ECU52 calculates an input/output limit Win, Wout which is an allowable input/output power of the battery 50 based on the power storage ratio SOC and the temperature Tb. The input/output limit Win, Wout is set such that the absolute value decreases as the temperature Tb decreases from the allowable temperature range. The battery ECU52 communicates with HVECU70.

HVECU70 comprises a microcomputer as well as an engine ECU24. HVECU70 receives signals from various sensors via input ports. For example, HVECU70 receives a signal from the power switch 80, a shift position SP, an accelerator operation amount Acc, a brake pedal position BP, and a vehicle speed V. The shift position SP is inputted from a shift position sensor 82 that detects the operating position of the shift lever 81. The accelerator operation amount Acc is inputted from an accelerator pedal position sensor 84 that detects the depression amount of the accelerator pedal 83. The brake pedal position BP is inputted from a brake pedal position sensor 86 that detects the depression amount of the brake pedal 85. The vehicle speed V is input from the vehicle speed sensor 87. As described above, HVECU70 communicates with the engine ECU24, the motor ECU40, and the battery ECU52.

In hybrid electric vehicle 20 of the embodiment, the engine 22 and the motors MG1, MG2 are controlled. The engine 22 and the motors MG1, MG2 are controlled by cooperative control of HVECU70, the engine ECU24, and the motor ECU38 so as to perform hybrid-running (HV running) and electric-running (EV running). HV travel is a travel accompanied by the operation of the engine 22. EV traveling is a traveling accompanied by a shutdown of the engine 22 (not accompanied by an operation).

In HV traveling, HVECU70 first sets a required torque Td* for traveling (required for the drive shaft 37) based on the accelerator operation amount Acc and the vehicle speed V. HVECU70 sets the required power Pd for traveling on the basis of the set required torque Td* and the rotational speed Nd of the drive shaft 37 (the rotational speed Nm2 of the motor MG2). Subsequently, HVECU70 sets the required power Pe* of the engine 22 based on the required power Pd* and the charge/discharge required power Pb* based on the power storage ratio SOC of the battery 50. HVECU70 sets the target rotational speed Ne* and the target torque Te* of the engine 22 and the torque command Tm1*, Tm2* of the motors MG1, MG2. This setting is performed such that the required power Pe* is output from the engine 22 and the required torque Td* is output to the drive shaft 37 within the input/output limit Win, Wout of the battery 50. Then, the target rotational speed Ne* and the target torque Te* of the engine 22 are transmitted to the engine ECU24, and the torque command Tm1*, Tm2* of the motors MG1, MG2 is transmitted to the motor ECU40. The engine ECU24 performs operation control (intake air amount control, fuel injection control, ignition control, and the like) of the engine 22 so that the engine 22 is operated based on the target rotational speed Ne* and the target torque Te*. The motor ECU40 controls the inverters 41 and 42 so that the motors MG1, MG2 are driven based on the torque command Tm1*, Tm2*.

In HV traveling, when the stopping condition of the engine 22 is satisfied, for example, when the vehicle speed V is less than the threshold Vref1 and the required torque Td* is less than the threshold Tdref and the required power Pd* is less than the threshold Pdref, the engine 22 is stopped and EV traveling is performed.

In EV running, HVECU70 first sets the required torque Td*, as in HV running. Subsequently, 0 is set to the torque command Tm1* of the motor MG1 and the required torque Td* is set to the required torque Td* in the torque command Tm2* of the motor MG2 so that the required torque Td* is outputted to the drive shaft 37 within the input/output limit Win, Wout of the battery 50. Then, the torque command Tm1*, Tm2* of the motors MG1, MG2 is transmitted to the motor ECU40. The motor ECU40 controls the inverters 41 and 42 so that the motors MG1, MG2 are driven by the torque command Tm1*, Tm2*.

In EV running, when the starting condition of the engine 22 is satisfied, the engine 22 is started with cranking of the engine 22 by the motor MG1, and HV running is performed. For example, the starting condition of the engine 22 is satisfied when the vehicle speed V reaches the threshold Vref1 (start determination vehicle speed) or higher. When the required torque Td* of the engine 22 reaches the threshold Tdref or more, the start-up condition is satisfied. The starting condition of the engine 22 is satisfied when the required power Pd* calculated in the same manner as in the case of HV running reaches a threshold Pdref or more. When the engine 22 is started, the motor MG1 (inverter 41) is controlled by setting a cranking torque Tcr for cranking the engine 22 to a torque command Tm1* of the motor MG1. The engine 22 starts fuel-injection control, ignition control, and the like when the rotational speed Ne of the engine 22 reaches a threshold Nsteg or higher. The motor MG2 (inverter 42) is controlled by setting the torque command Tm2* so that the required torque Td* is outputted to the drive shaft 37 within the input/output limit Win, Wout of the battery 50.

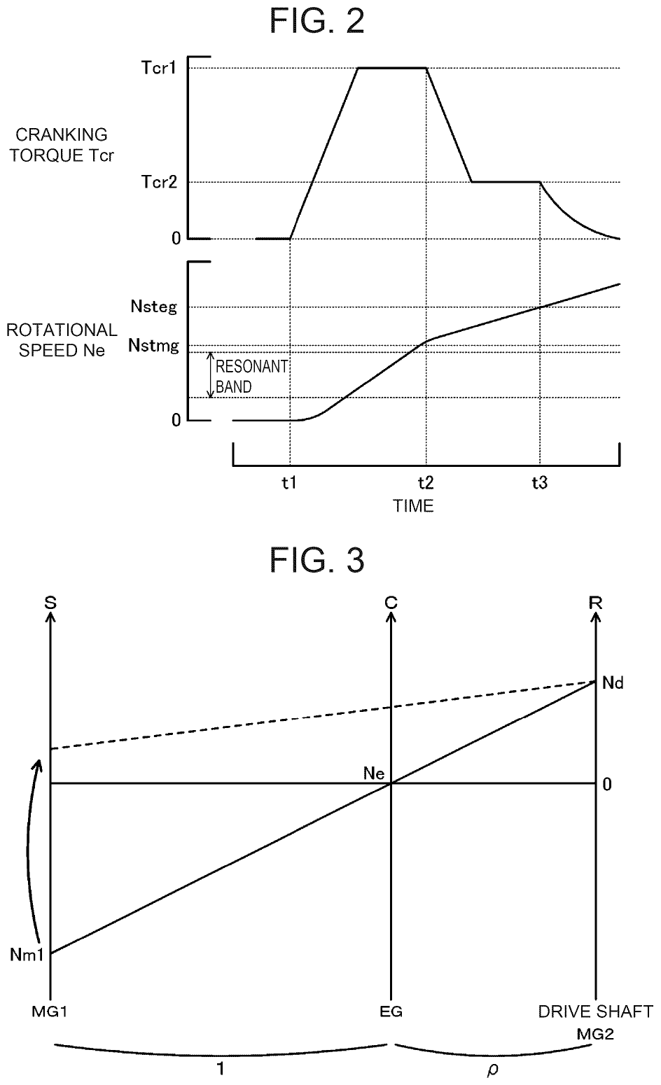

Here, the cranking torque Tcr can be set as follows, for example. FIG. 2 is an explanatory diagram illustrating an exemplary configuration of a cranking torque Tcr. In FIG. 2, when the starting condition of the engine 22 is satisfied (time t1), the cranking torque Tcr is increased from a value of 0 to a relatively large first torque Tcr1. As a result, the rotational speed Ne of the engine 22 can be rapidly increased, and the resonant band (for example, about 400 rpm to 600 rpm) can be rapidly passed. When the decreasing starting condition is satisfied (time t2), the cranking torque Tcr is decreased from the first torque Tcr1 to a second torque Tcr2 smaller than the first torque Tcr1. Accordingly, power dissipation of the motor MG1 can be suppressed. The decreasing starting condition includes a rotational speed condition in which the rotational speed Ne of the engine 22 is equal to or higher than the rotational speed Nstmg slightly larger than the resonant band. Further, when the rotational speed Ne of the engine 22 reaches the threshold Nsteg or more (time t3), the cranking torque Tcr is decreased from the second torque Tcr2 to 0. When the engine 22 is fully exploded and the starting of the engine 22 is completed, electric power is generated by the motor MG1 using the torque from the engine 22.

FIG. 3 is an explanatory diagram illustrating an example of a relationship between rotational speeds of rotating elements of the planetary gear 30 when the engine 22 is started. In the drawing, the S-axis represents the rotational speed of the sun gear 31, which is the rotational speed Nm1 of the motor MG1. The C-axis represents the rotational speed of the carrier 34, which is the rotational speed Ne of the engine 22. The R-axis represents the rotational speed of the ring gear 32, which is the rotational speed Nd of the drive shaft 37 (the rotational speed Nm2 of the motor MG2). In the drawing, a solid line is a collinear diagram at the start of the engine 22, and a broken line is a collinear diagram at the start of the engine 22. As can be seen from FIG. 3, the motor MG1 is regeneratively driven at the beginning of cranking of the engine 22, and the motor MG1 is driven by power after the rotational speed Ne of the motor MG1 straddles 0. Incidentally, as the vehicle speed V (the rotational speed Nd of the drive shaft 36) is higher, the rotational speed Nm1 of the motor MG1 at the time of starting the engine 22 becomes smaller (becomes larger toward the negative side). Therefore, the power generated by the regenerative driving of the motor MG1 becomes large at the beginning of cranking of the engine 22, and the inputted power of the battery 50 becomes large. Based on this, the above-described threshold Vref1 (start determination vehicle speed) is set so that the input power of the battery 50 when the engine 22 is started during traveling is within the input limit Win. As described above, the input limit Win of the battery 50 is set such that the absolute value decreases as the temperature Tb of the battery 50 moves from the allowable temperature range to the lower side. Therefore, the threshold Vref1 (start determination vehicle speed) is also set to be lower as the temperature Tb is lower.

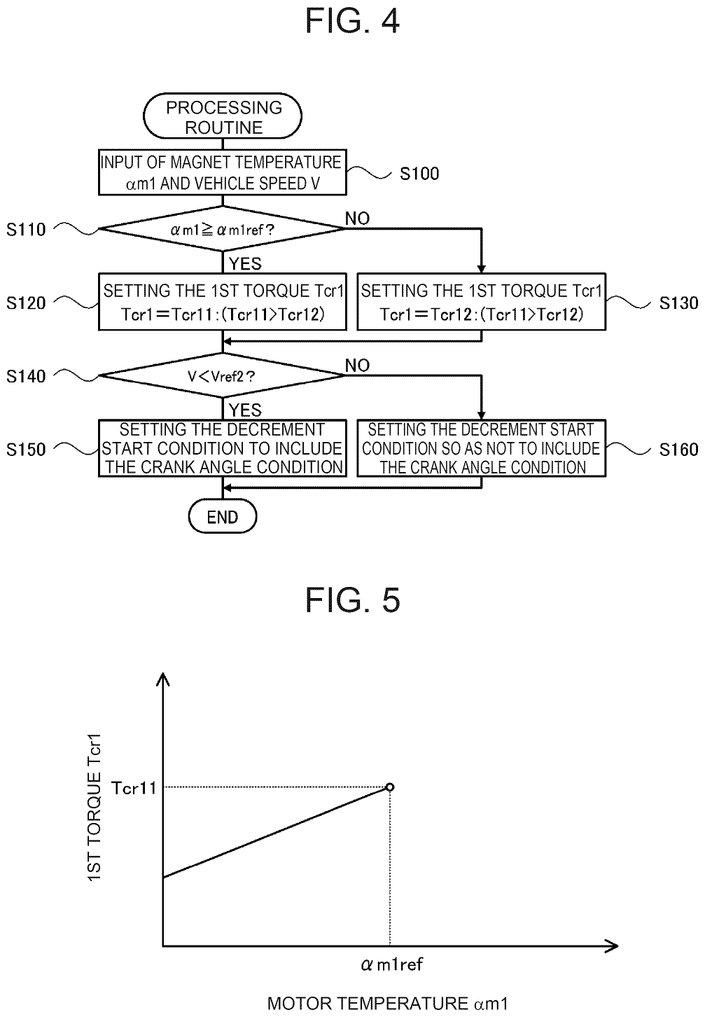

Next, the operation of hybrid electric vehicle 20 according to the embodiment, in particular, the process of setting the first torque Tcr1 and the reduction-start condition will be described. FIG. 4 is a flow chart illustrating a process routine executed by HVECU70. This routine is executed when the starting condition of the engine 22 is satisfied while the vehicle is running in EV running.

When the process of FIG. 4 is executed, HVECU70 first inputs the temperature αm1 and the vehicle speed V of the motor MG1 (S100). Here, the temperature αm1 of the motor MG1 is detected by the temperature sensor 45 and is inputted from the motor ECU40 by communication. The vehicle speed V is detected and input by the vehicle speed sensor 87.

Subsequently, it is determined whether or not the temperature αm1 of the motor MG1 is less than the threshold am ref (S110). Here, the thresholds αm1ref are used to determine whether the actual torque Tm1 of the motor MG1 can increase to some extent with respect to the torque command Tm1*. As the threshold αm1ref, for example, about 0° C. to −30° C. is used. The torque of the motor MG1 is composed of a magnet torque and a reluctance torque. The present inventors have made intensive studies to confirm that, with respect to the motor MG1, the magnet torque becomes larger as the temperature αm1 is lower with respect to the same torque command Tm1*, and thus the actual torque Tm1 becomes larger. S110 process is a process based on this.

When it is determined that the temperature αm1 of the motor MG1 is equal to or higher than the threshold αm1ref, it is determined that the actual torque Tm1 of the motor MG1 does not become so large with respect to the torque command Tm1*. Then, the predetermined value Tcr11 is set to the first torque Tcr1 (S120), and the process proceeds to S140. On the other hand, when it is determined that the temperature αm1 of the motor MG1 is less than the threshold αm1ref, it is determined that the actual torque Tm1 of the motor MG1 can be increased to some extent with respect to the torque command Tm1*. Then, a predetermined torque Tcr12 smaller than the predetermined value Tcr11 is set to the first torque Tcr1 (S130), and the process proceeds to S140.

As described above, when the temperature αm1 of the motor MG1 is less than the threshold value αm1ref, the first torque Tcr1 is made smaller than when the temperature αm1 of the motor MG1 is equal to or greater than the threshold value αm1ref. Accordingly, the cranking torque Tcr, that is, the torque command Tm1*, is set. Thus, when the temperature αm1 of the motor MG1 is less than the threshold value αm1ref, the actual torque Tm1 of the motor MG1 can be suppressed from becoming larger than when the temperature αm1 of the motor MG1 is greater than or equal to the threshold value αm1ref. Therefore, when the temperature αm1 of the motor MG1 is less than the threshold αm1ref, it is possible to suppress the input power of the battery 50 from becoming relatively large. This suppresses the power generated by the regenerative driving of the motor MG1 from becoming relatively large at the beginning of cranking of the engine 22. In particular, when the first torque Tcr1 is set to the cranking torque Tcr, that is, the torque command Tm1*, the generated electric power generated by regenerative driving of the motor MG1 is suppressed from being relatively large. Consequently, when the temperature αm1 of the motor MG1 is less than the threshold value αm1ref, it is possible to suppress setting of the threshold value Vref1 (start determination vehicle speed) relatively low and to suppress narrowing of the allowable vehicle speed range of EV travel.

When the first torque Tcr1 is set by S120 or S130, it is determined whether or not the vehicle speed V is equal to or higher than the threshold Vref2 (S140). Here, the threshold Vref2 is used to determine whether the cranking torque Tcr is susceptible to road noise when vibrations occur when decreasing from the first torque Tcr1. The threshold Vref2 is determined within the above-described threshold Vref1 (starting determination vehicle speed), and, for example, about several tens of km/h is used.

When it is determined that the vehicle speed V is less than the threshold Vref2, it is determined that when the cranking torque Tcr is decreased from the first torque Tcr1, when the oscillation occurs, it is difficult to be mixed with the road noise. Then, a decreasing condition is set to include a crank angle condition in which the crank angle θcr is within the predetermined crank angle range (S150), and the routine ends. At this time, the reduction start condition includes the crank angle condition and the above-described rotational speed condition as an AND condition. The predetermined crank angle range is determined in advance by experimentation, analysis, machine learning, or the like so that the maximal vibration when the cranking torque Tcr is reduced from the first torque Tcr1 is within the allowable vibration range. When the cranking torque Tcr is reduced from the first torque Tcr1, it is possible to prevent a relatively large oscillation from occurring.

On the other hand, when it is determined that the vehicle speed V is equal to or higher than the threshold Vref2, it is determined that when the cranking torque Tcr is decreased from the first torque Tcr1 and oscillation occurs, it is likely to be mixed with the road noise. Then, the decreasing condition is set so as not to include the crank angle condition (S150), and the routine ends. As a result, it is possible to suppress the time until the decrease start condition is satisfied from becoming longer than when the decrease start condition includes the crank angle condition. Therefore, the cranking torque Tcr is suppressed from increasing in duration in the first torque Tcr1. It is possible to suppress a long duration when the electric power of the motor MG1 (generated electric power or consumed electric power depending on the rotational speed of the motor MG1) is relatively large. Incidentally, as the vehicle speed V (the rotational speed Nd of the drive shaft 36) is higher, the rotational speed Nm1 of the motor MG1 at the time of starting the engine 22 becomes smaller (becomes larger toward the negative side). Therefore, when the cranking torque Tcr is held at the first torque Tcr1, the motor MG1 is easily regenerated and driven. By suppressing a long duration when the electric power (particularly generated electric power) of the motor MG1 is relatively large, the threshold Vref1 (start determination vehicle speed) can be further increased, and the allowable vehicle speed range of EV travel can be enlarged.

In hybrid electric vehicle 20 of the present embodiment described above, the engine 22 is started with cranking of the engine 22 by the motor MG1 during traveling. At this time, the cranking torque Tcr that increases from the value 0 to the first torque Tcr1 and then decreases when the decreasing starting condition is satisfied is set to the torque command Tm1*, and the motor MG1 (inverter 41) is controlled. In this case, when the temperature αm1 of the motor MG1 is less than the threshold αm1ref, the first torque Tcr1 is made smaller than when the temperature αm1 of the motor MG1 is equal to or greater than the threshold αm1ref, thereby reducing the cranking torque Tcr. Thus, when the temperature αm1 of the motor MG1 is less than the threshold value αm1ref, the actual torque Tm1 of the motor MG1 can be suppressed from becoming larger than when the temperature αm1 of the motor MG1 is greater than or equal to the threshold value αm1ref. Therefore, when the temperature αm1 of the motor MG1 is less than the threshold αm1ref, the generated electric power generated by the regenerative driving of the motor MG1 at the beginning of cranking of the engine 22 is suppressed from being relatively large. Therefore, it is possible to suppress the input power of the battery 50 from becoming relatively large. Consequently, when the temperature αm1 of the motor MG1 is less than the threshold value αm1ref, it is possible to suppress setting of the threshold value Vref1 (start determination vehicle speed) relatively low and to suppress narrowing of the allowable vehicle speed range of EV travel.

Further, in hybrid electric vehicle 20 of the embodiment, when the vehicle speed V is less than the threshold Vref2, the decreasing starting condition is set to include the crank angle condition. When the vehicle speed V is equal to or higher than the threshold Vref2, the decreasing starting condition is set so as not to include the crank angle condition. Accordingly, when the vehicle speed V is equal to or higher than the threshold Vref2, it is possible to suppress a long duration when the electric power of the motor MG1 (particularly, generated electric power) is relatively large. Consequently, the threshold Vref1 (start determination vehicle speed) can be made higher, and the allowable vehicle speed range of EV travel can be enlarged.

In the above-described embodiment, when the temperature αm1 of the motor MG1 is less than the threshold αm1ref, the predetermined torque Tcr12 is set to the first torque Tcr1, but the present disclosure is not limited thereto. For example, the first torque Tcr1 may be set within a predetermined torque Tcr11 by using the temperature αm1 of the motor MG1 and the low-temperature map. The low-temperature map is determined in advance by experimentation, analysis, machine-learning, or the like as a relation between the temperature αm1 of the motor MG1 and the first torque Tcr1. The first torque Tcr1 can be set by applying the temperature αm1 of the motor MG1 to the low-temperature map and deriving the corresponding first torque Tcr1 from the low-temperature map. FIG. 5 is an explanatory diagram illustrating an example of a low-temperature map. As illustrated in FIG. 5, the first torque Tcr1 is determined to be smaller as the temperature αm1 of the motor MG1 is lower, within a predetermined torque Tcr1. Thus, when the temperature αm1 of the motor MG1 is less than the threshold value αm1ref, the actual torque Tm1 of the motor MG1 can be more appropriately suppressed from becoming larger than when the temperature αm1 of the motor MG1 is greater than or equal to the threshold value αm1ref. Therefore, when the temperature αm1 of the motor MG1 is less than the threshold αm1ref, the generated electric power generated by the regenerative driving of the motor MG1 at the beginning of cranking of the engine 22 is more appropriately suppressed from becoming relatively large. Therefore, it is possible to more appropriately suppress the input power of the battery 50 from becoming relatively large.

In the above-described embodiment, when the temperature αm1 of the motor MG1 is less than the threshold value αm1ref, the first torque Tcr1 is made smaller than when the temperature αm1 of the motor MG1 is equal to or greater than the threshold value αm1ref. Accordingly, the cranking torque Tcr is reduced, but the present disclosure is not limited thereto. For example, when the temperature αm1 of the motor MG1 is equal to or higher than the threshold αm1ref, the cranking torque Tcr may be set as shown in FIG. 2. When the temperature αm1 of the motor MG1 is less than the threshold αm1ref, the cranking torque Tor may be set by multiplying the cranking torque Tor when the temperature αm1 of the motor MG1 is greater than or equal to the threshold αm1ref by a correcting factor kcr smaller than the threshold 1.

In the above-described embodiment, when the vehicle speed V is less than the threshold Vref2, the decreasing starting condition is set to include the crank angle condition. When the vehicle speed V is equal to or higher than the threshold Vref2, the decreasing starting condition is set so as not to include the crank angle condition. However, the present disclosure is not limited thereto. For example, the decreasing start condition may be set to include the crank angle condition regardless of the vehicle speed V.

In the above-described embodiment, hybrid electric vehicle 20 includes the battery 50 as the power storage device, but is not limited thereto. For example, a capacitor or the like may be provided as the power storage device.

In the above-described embodiment, hybrid electric vehicle 20 includes, but is not limited to, an engine ECU24, a motor ECU40, a battery ECU52, and a HVECU70. For example, at least two of the engine ECU24, the motor ECU40, the battery ECU52, and HVECU70 may be integrally formed.

In the above-described embodiments, although not specifically described, hybrid electric vehicle 20 may be configured to be chargeable using electric power from an external power source.

The correspondence between the main elements of the embodiments and the main elements of the disclosure described in the column of the means for solving the problem will be described. In the embodiment, the engine 22 corresponds to an “engine”. The motor MG1 corresponds to the “first motor”. The planetary gear 30 corresponds to a “planetary gear”. The motor MG2 corresponds to the “second motor”. The battery 50 corresponds to a “power storage device”. The engine ECU24, the motor ECU40, and HVECU70 correspond to a “control device”.

The correspondence between the main elements of the embodiment and the main elements of the disclosure described in the section of the means for solving the problem is an example for specifically explaining the embodiment of the disclosure described in the section of the means for solving the problem. Therefore, the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Although the embodiments for carrying out the present disclosure have been described using the embodiments, it is needless to say that the present disclosure is not limited to such embodiments, and can be implemented in various forms without departing from the gist of the present disclosure.

The present disclosure is applicable to a manufacturing industry of a hybrid electric vehicle and the like.

What is claimed is:

1. A hybrid electric vehicle comprising:
an engine;
a first motor;
a planetary gear that is connected to the first motor, the engine, and a drive shaft connected to drive wheels;
a second motor that is connected to the drive shaft;
a power storage device that is connected to the first motor and the second motor via a power line; and
a control device that controls the engine, the first motor, and the second motor to travel with an intermittent operation of the engine, wherein
if a temperature of the first motor is less than a predetermined temperature when a start condition is met during traveling and the engine is started with cranking of the engine achieved by the first motor, the control device sets a smaller value than a value set when the temperature of the first motor is equal to or greater than the predetermined temperature in a torque command of the first motor and controls the first motor.

2. The hybrid electric vehicle according to claim 1, wherein:
the control device sets a start determination vehicle speed such that input power of the power storage device when the engine is started during traveling falls within a range of allowable input power; and
the start condition includes a condition that a vehicle speed is equal to or greater than the start determination vehicle speed.

3. The hybrid electric vehicle according to claim 1, wherein if the temperature of the first motor is less than the predetermined temperature when the engine is started during traveling, the control device sets a smaller value in the torque command as the temperature of the first motor is lower.

4. The hybrid electric vehicle according to claim 1, wherein:
the control device sets the torque command such that a torque increases up to a first torque, is held, and then decreases once a decreasing start condition is met when the engine is started during traveling; and
the decreasing start condition includes a crank angle condition that a crank angle of the engine falls within a predetermined crank angle range when a vehicle speed is less than a predetermined vehicle speed, and the decreasing start condition does not include the crank angle condition when the vehicle speed is equal to or greater than the predetermined vehicle speed.
